(19) United States
(12) Patent Application Publication
(10) Pub. No.: US 2011/0075640 A1
(43) Pub. Date: Mar. 31, 2011

(54) Method, System and Mobile Station for Obtaining Information

(75) Inventors: Junxian Mo, Shenzhen (CN); Jia Lin, Shenzhen (CN)

(73) Assignee: HUAWEI TECHNOLOGIES CO., LTD., Shenzhen (CN)

(21) Appl. No.: 12/960,202

(22) Filed: Dec. 3, 2010

Related U.S. Application Data
(63) Continuation of application No. PCT/CN2009/071370, filed on Apr. 20, 2009.

(30) Foreign Application Priority Data
Jun. 5, 2008 (CN) 200810111256.4

(51) Int. Cl. H04W 72/04

(52) U.S. Cl. 370/336

(57) ABSTRACT

A method for obtaining information includes receiving carrier information and offset information of other carriers carried on a primary carrier, where the offset information includes frame number information, time difference information or window information; and obtaining, according to the carrier information and the offset information, data resources carried on the other carriers.

This application is a continuation of co-pending International Application No. PCT/CN2009/071370, filed Apr. 20, 2009, which designated the United States and was not published in English, and which claims priority to Chinese Application No. 200810111256.4, filed Jun. 5, 2008, both of which applications are incorporated herein by reference.

### TECHNICAL FIELD

The present invention relates to the field of communications technologies, and in particular, to a method, a system and a mobile station (MS) for obtaining information.

### BACKGROUND

With the development of the communications technologies, Worldwide Interoperability for Microwave Access (WiMAX), also known as the 802.16 wireless Metropolitan Area Network (MAN) has developed rapidly. The technology is a broadband wireless access solution that provides “the last mile” for enterprise and home users, can achieve a wide coverage area in the field of data communication (a coverage area of 25 to 30 miles), and is based on the broadband wireless standards of the IEEE 802.16 series. The Institute of Electrical and Electronics Engineers (IEEE) 802.16 standard series currently includes seven standards, namely, 802.16, 802.16a, 802.16c, 802.16d, 802.16e, 802.16f and 802.16g, among which the 802.16, 802.16a and 802.16d belong to fixed wireless access air interface standards, and the 802.16e belongs to mobile broadband wireless access air interface standards.

The WiMAX adopts the 802.16 standard series as its air interface protocol, where the IEEE 802.16e is a mobile broadband wireless access standard, and is backwards compatible with the IEEE 802.16d. The implementing method of a physical layer of the IEEE 802.16e is basically the same as that of the IEEE 802.16d, and the main difference lies in that Orthogonal Frequency Division Multiple Access (OFDMA) is expanded in the IEEE 802.16e to support 2048-Point, 1024-Point, 512-Point and 128-Point, so as to adapt to the requirements of different carrier bandwidths; meanwhile, to support the mobility, many new features are introduced in a Medium Access Control (MAC) layer of the 802.16e; and in addition, by introducing new technologies such as Orthogonal Frequency Division Multiplex (OFDM) and Multiple-Input Multiple-Output (MIMO), higher capacity, larger coverage and mobility of certain degree can be achieved, so that the 802.16e and the third generation (3G) mobile communications networks can coexist and complement each other. Meanwhile, based on the 802.16e, the WiMAX puts forward a new enhanced technology 802.16m, which can be adopted on a moving object with a speed over 350 km/h, requires a maximum downlink data transmission rate over 350 Mbps and a maximum uplink data transmission rate not less than 200 Mbps, and is compatible with the 802.16e.

At the same time, the multi-carrier technology has also developed rapidly. The bandwidth of a multi-carrier system may be upgraded or expanded; the entire bandwidth is divided into multiple carriers, for example, a bandwidth of 20 MHZ may be divided into four carries, each carrier has a bandwidth of 5 MHZ, and an MS may use a certain carrier to access the network. In the multi-carrier system, when the MS has a capability of demodulating on all carriers in the system simultaneously, the system may dispatch resources to the MS from all carriers simultaneously, and thus a high peak rate can be provided to meet the requirements of some services for high peak rates. Under a multi-carrier condition, one or more primary carriers may exist in the system, which may transmit control information and resource assignment information, and definitely may transmit data; meanwhile, one or more secondary carriers may exist, which are mainly for transmitting data, but in some cases may also transmit information such as control signaling or resource assignment information. The system may assign one or more primary carriers to an MS, and the MS receives, on the corresponding primary carrier, control information and resource assignment information of the MS, where the resource assignment information may assign resources of the current frame or other frames.

During the implementation of the present invention, the inventor finds that the prior art has the following problems. In most cases of the multi-carrier system, an MS (receives, on the corresponding primary carrier, control information and resource assignment information of the MS, where the resource assignment information may assign resources of the current carrier or other carriers of the same frame or different frames. Since the resources of other carriers of the same frame may be assigned, the MS needs to receive and buffer information of all the carriers that are supported by the MS. When the MS reads the related resource assignment information from the primary carrier, and finds that the assignment information assigns the resources of the current frame of another carrier, the MS will read the part assigned to the MS from the buffered carrier information. That is to say, in the current resource assignment method, the MS needs to buffer information of all the carriers that may assign resources to the MS, and read the related content according to the indication of the resource assignment information in the primary carrier. However, the operation of receiving and buffering the carrier information is rather power-consuming, and for the performance of the MS, power saving is an important index. Therefore, in this assignment mode, the power saving effect of the MS is rather undesirable.

### SUMMARY OF THE INVENTION

The present invention is directed to a method, a system and an MS for obtaining information, so as to achieve the power saving effect of the MS while ensuring the performance of the system.

An embodiment of the present invention provides a method for obtaining information. Carrier information and offset information of other carriers carried on a primary carrier are received. The offset information includes frame number information, time difference information or window information, and the other carriers include secondary carriers. According to the carrier information and the offset information, data resources carried on the other carriers are obtained.

An embodiment of the present invention provides a mobile station (MS) that includes a receiving unit that is configured to receive carrier information and offset information of other carriers carried on a primary carrier. The offset information includes frame number information, time difference information or window information, and the other carriers include secondary carriers. An obtaining unit is configured to obtain data resources carried on the other carriers according to the carrier information and the offset information.

An embodiment of the present invention provides a system for obtaining information. The system includes a mobile station that includes a receiving unit that is configured to receive carrier information and offset information of other carriers carried on a primary carrier by a base station (BS). The offset information includes frame number information, time difference information or window information, and the other carriers include secondary carriers. An obtaining unit is configured to obtain data resources carried on the other carriers according to the carrier information and the offset information.

Through embodiments of the method, system and MS for obtaining information, the MS obtains, according to the received carrier information and offset information, the resources assigned to the MS, and does not need to receive and buffer the data of each frame of all the carriers that may assign resources to the MS. This greatly reduces the amount of data received and buffered by the MS, and improves the power saving performance of the MS.

The technical solutions of the present invention will be described in detail in the following with reference to the accompanying drawings and embodiments.

### BRIEF DESCRIPTION OF THE DRAWINGS

FIG. 1 is a flow chart of a method for obtaining information according to an embodiment of the present invention;

FIG. 2 is a flow chart of signaling of a method for obtaining information according to a first embodiment of the present invention;

FIG. 3 is a schematic view of a process of the method for obtaining information according to the first embodiment of the present invention;

FIG. 4 is a flow chart of signaling of a method for obtaining information according to a second embodiment of the present invention;

FIG. 5 is a schematic view of a process of the method for obtaining information according to the second embodiment of the present invention;

FIG. 6 is a flow chart of signaling of a method for obtaining information according to a third embodiment of the present invention;

FIG. 7 is a schematic view of a window indication of the method for obtaining information according to the third embodiment of the present invention;

FIG. 8 is a schematic structural view of an MS according to an embodiment of the present invention; and

FIG. 9 is a schematic structural view of a system for obtaining information according to an embodiment of the present invention.

### DETAILED DESCRIPTION OF ILLUSTRATIVE EMBODIMENTS

An embodiment of the present invention provides a method for obtaining information. The method includes receiving carrier information and offset information of other carriers carried on a primary carrier. The offset information includes frame number information, time difference information or window information, and the other carriers include secondary carriers. Data resources carried on the other carriers are obtained, according to the carrier information and the offset information.

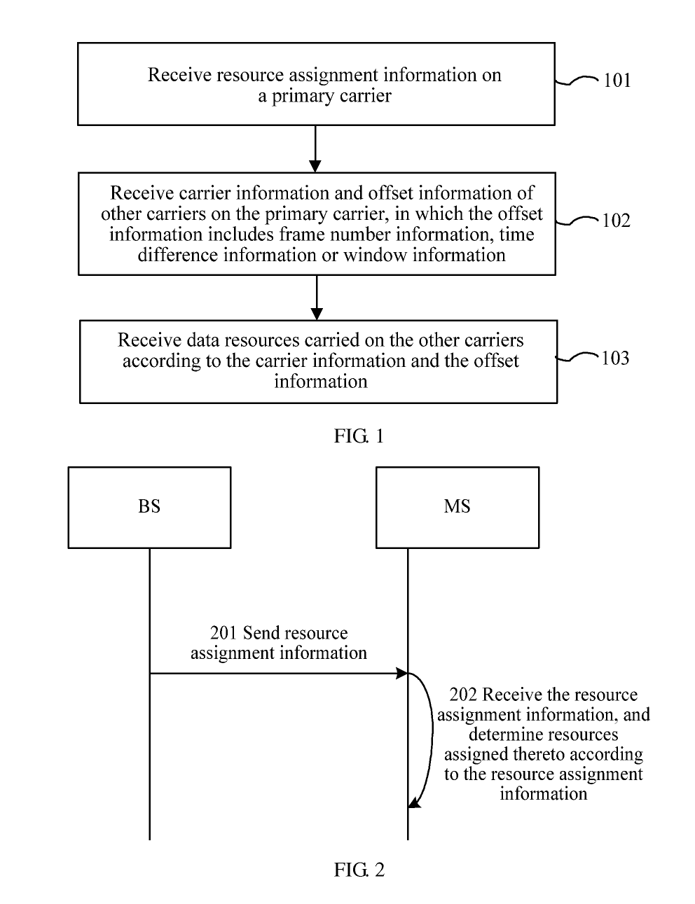

FIG. 1 is a flow chart of a method for obtaining information according to an embodiment of the present invention. As shown in FIG. 1, the method includes the following steps.

Step 101: Resource assignment information on a primary carrier is received.

After a BS sends the resource assignment information to an MS through the primary carrier, the MS receives the resource assignment information from the primary carrier; if the assigned resources are on the primary carrier, the resources of the current frame may be assigned, or the resources of the subsequent frames may be assigned.

Step 102: Carrier information and offset information of other carriers carried on the primary carrier are received, where the offset information includes frame number information, time difference information or window information.

The MS needs to receive the carrier information of the other carriers, and the carrier information may include information such as a carrier index, a center frequency, or a bandwidth. The specific one of the other carriers where the resources are assigned may be obtained through the carrier information.

In addition, if the resources assigned by the primary carrier are on the other carriers, the assigned resources appear in a subsequent frame only, that is, a time offset exists between the subsequent frame and the current frame. The granularity of the offset may be super-frame, frame or sub-frame, and the quantity is uncertain. The BS may notify the MS of the offset information through broadcast, unicast or in a preset manner. The offset information may be based on the carrier or the MS. The offset information may include frame number information, time difference information or window information. The specific frame or window of the specific one of the other carriers where the resources are assigned may be obtained through the carrier information and the offset information.

Step 103: Data resources carried on the other carriers are obtained according to the carrier information and the offset information.

The MS obtains the specific assigning location according to the carrier information and the offset information, and obtains data resources of the other carriers according to the assigning location.

In the method for obtaining information according to this embodiment, the resources of multiple carriers simultaneously assigned by the BS to the MS are not reduced, and only the resource scheduling is changed. That is, the resources of the other carriers are assigned by the frame previous to the primary carrier, but not the current frame. From the angle of the BS scheduling the service data, whether the data of the service is scheduled one frame in advance, or at the current frame, the user experience is not affected. Since the system provides instantaneous high bandwidth, the capability of scheduling the data on all the carriers to an MS is not reduced, and thus the above method can well ensure the performance of the system. In addition, in the above method for obtaining information, the MS does not need to receive and buffer the data of each frame of all the carriers that may assign resources to the MS, but instead, only needs to receive data frames of other carriers that explicitly assign resources to the MS in the resource assignment information of the primary carrier or a part of resource blocks specified in the data frame. This greatly reduces the amount of data received and buffered by the MS, and improves the power saving performance of the MS.

FIG. 2 is a flow chart of signaling of a method for obtaining information according to a first embodiment of the present invention. As shown in FIG. 2, in a multi-carrier system according to this embodiment, an MS may support simultaneous demodulation of two carriers, and it is assumed that carrier 1 is a primary carrier, and carrier 2 is a secondary carrier. The method includes the following steps.

Step 201: A BS puts resource assignment information on the primary carrier and sends the information to the MS.

An access device at the network side, such as the BS, puts the resource assignment information of the MS on the carrier 1 for transmission. If the assigned resources are on carrier 1, a time-frequency resource area where the resources are located may be directly assigned. The MS receives and buffers the time-frequency resources of the entire current frame of carrier 1, and demodulates the resource assignment information in the frame. Generally speaking, the resource assignment information of each frame will broadcast a time-frequency area occupied by the resource assignment information and broadcast a demodulating mechanism in a preset modulation and coding mode, and after obtaining the information, the MS may decode the resource assignment information according to the indication, and find corresponding assignment information from all the resource assignment information.

After decoding the related resource assignment information, the MS will obtain the time-frequency area occupied by the resources assigned by the BS to the MS and obtain the related demodulating mechanism. In addition, the BS may also broadcast the resource assignment information in the preset modulation and coding mode and with a fixed location size, so as to facilitate the MS to decode the information. Moreover, the BS may also first broadcast a resource area where the assignment information corresponding to the MS is located, and then assign a time-frequency area where the resources corresponding to the MS are located by unicasting the resource assignment information in the resource area. Other methods are not described in detail herein one by one.

If the resources to be assigned by the BS to the MS are on carrier 2, carrier information, frame number information, related physical layer encoding and decoding information of the frame and time-frequency block information assigned to the MS in the frame are pointed out in the resource assignment information corresponding to the MS, where the carrier information and the frame number information are compulsory, and other information is optional.

The carrier information may include information such as a carrier index, a center frequency, or a bandwidth. The frame number information may include a supper frame number, a frame number, or a sub frame number. To optimize and save the number of bits of the frame number, a relative frame number may be adopted to substitute the normal frame number; the relative frame number is the frame number counted from the current frame, and is relative to the sequence of the current frame, and the frame number information is frame number information of a data frame succeeding the current frame. The related physical layer encoding and decoding information of the frame may include information such as downlink modulation and coding system (MCS) information, a transmission power of the BS, transmit/receive transition time of the BS, acknowledgement (ACK) delay and maximum retransmission times. The time-frequency resource block information assigned to the MS in the frame may include an one-dimensional identification of a time-frequency resource block assigned to the MS (such as an index number of the resource block) or a two-dimensional identification (such as a time beginning, a frequency beginning, a time length and a frequency length of the resource block), and may assign information of one or more resource blocks simultaneously.

Step 202: The MS receives the resource assignment information, and determines, according to the resource assignment information, resources assigned to the MS.

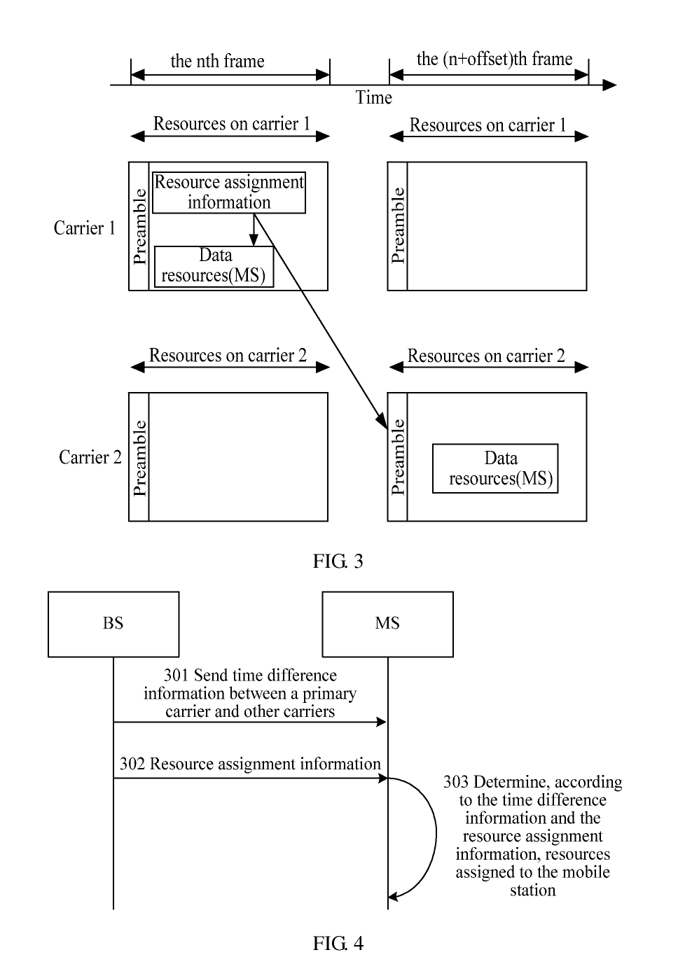

FIG. 3 is a schematic view of a process of the method for obtaining information according to the first embodiment of the present invention. As shown in FIG. 3, the MS receives the resource assignment information of carrier 1 on the n^{th} frame, and obtains the data resources of the MS on carrier 2 through information of carrier 2 on the (n+offset)^{th} frame included in the resource assignment information.

Specifically, after receiving the resource assignment information, the MS may determine, through the following method, the resources assigned to the MS.

The MS receives and buffers a data frame (the data frame may also be called a specific frame) indicated by the resource assignment information, and reads, according to the previous assignment information, data resources assigned to the MS in the specific frame. Alternatively, the MS receives and buffers, according to the previous assignment information, the data resources assigned to the MS in the specific frame, and reads the data resources according to the modulation and coding mode indicated in the assignment information. Alternatively, the MS receives and buffers the specific frame indicated by the resource assignment information and reads the resource assignment information on the specific frame to obtain the resource assignment information of the MS, and then reads, according to the assignment information, the data resources assigned to the MS.

Through the above method for obtaining information, the MS obtains, according to the received carrier information and frame number information, the resources assigned to the MS, and does not need to receive and buffer the data of each frame of all the carriers that may assign resources to it, this greatly reduces the amount of data received and buffered by the MS, and improves the power saving performance of the MS.

FIG. 4 is a flow chart of signaling of a method for obtaining information according to a second embodiment of the present invention. As shown in FIG. 4, the method includes the following steps.

Step 301: A BS sends time difference information between a primary carrier and other carriers to an MS.

A network side entity, such as the BS, sends the time difference information between the primary carrier and the other carriers to the MS through broadcast or unicast. The time difference information points out a time difference in terms of assignment between the current primary carrier and the other carriers, for example, a time difference of 1 super frame, 2 frames or 5 sub frames, which may also be counted in other time units such as millisecond. It should be noted that the time difference in terms of assignment between the current primary carrier and different other carriers may be different, for example, the time difference between the current primary carrier and the carrier 2 is 1 super frame, and the time difference between the current primary carrier and the carrier 3 is 2 super frames.

Step 302: Resource assignment information of the other carriers carried on the primary carrier by the BS is sent to the MS.

The BS sends the resource assignment information to the MS on the primary carrier corresponding to the MS. When the assigned resources are not on the current primary carrier, carrier information of the data resources may be pointed out in a resource assignment message, and the carrier information is compulsory information; meanwhile, more information may be pointed out, such as related physical layer encoding and decoding information of the frame, and time-frequency resource block information assigned to the MS in the frame, but the information is optional.

Step 303: The MS determines, according to the time difference information and the resource assignment information, resources assigned to the MS.

The MS obtains the time difference between the primary carrier and the other carriers from a broadcast message or a unicast message sent by the BS, and further obtains the specific assignment information according to the carrier information in the resource assignment information, the related physical layer encoding and decoding information of the frame, and the time-frequency resource block information assigned to the MS in the frame. For example, if the message points out that the time difference between the current primary carrier and the carrier 2 is 1 super frame, the MS receives the resource assignment information on the current primary carrier, and the information includes the content that the carrier information is carrier 2, then the MS will receive and buffer the information of the carrier 2 after 1 super frame, read the resource assignment information of the carrier 2 from the information to obtain the corresponding resource assignment information, and then read the corresponding data resources according to the resource assignment information. Definitely, if the resource assignment information further includes the specific resource block information, the MS may directly read the data resources corresponding to the carrier 2.

In addition, in step 301, the time difference information between the primary carrier corresponding to the MS and the other carriers is preset, such as 1 super frame, or 5 sub frames; moreover, the time differences between the primary carrier corresponding to the MS and the other carriers may be identical, or may vary with different other carriers. In this way, during assignment, except for the resource assignment information of the primary carrier, as for the assignment information of the other carriers, only the carrier information needs to be given.

FIG. 5 is a schematic view of a process of the method for obtaining information according to the second embodiment of the present invention. It is assumed that the MS can support simultaneous demodulation of carrier 1, carrier 2 and carrier 3, where carrier 1 and carrier 2 are primary carriers, carrier 3 is a secondary carrier, and the primary carrier corresponding to the MS is carrier 2. The BS sends resource assignment information to the MS on the primary carrier 2 corresponding to the MS; if the resources of the MS exist on the (n+2)^{th} super frames of carrier 1 and carrier 3, the carrier information of carrier 1 and carrier 3 should be pointed out in the resource assignment message of the (n+1)^{th} super frame of carrier 2.

The carrier information of multiple carriers may be indicated by a Bitmap or a link list, for example, 2 bits are used to map carrier 1 and carrier 3; when the Bitmap is 01, it shows that the carrier information of carrier 3 is carried, and when the Bitmap is 11, it shows that the carrier information of carrier 1 and carrier 3 is carried. The MS obtains, according to the carrier information in the resource assignment information and the preset time difference information (such as 1 super frame), the frame of the carrier that has the data resources of the MS. For example, if the preset time difference between the primary carrier and carrier 1 and carrier 3 is 1 super frame, and the resource assignment information currently received by the MS on the main sense carrier includes the carrier information of carrier 1 and carrier 3, the MS will receive and buffer the information of carrier 1 and carrier 3 after 1 super frame. Definitely, different time differences may be preset between the primary carrier and carrier 1 and carrier 3, for example, the time difference between the primary carrier and carrier 1 is 1 super frame, and the time difference between the primary carrier and carrier 3 is 3 super frames.

Further, compared with the method for obtaining information according to the first embodiment of the present invention, the method for obtaining information according to this embodiment only needs to notify the MS of the time difference between the carriers through the broadcast message or unicast message, and does not need to notify the MS of the frame number information through the resource assignment information, which greatly saves the overhead of pointing out the time difference information between the carriers each time the resources are assigned. Moreover, the broadcast message and the unicast message may be transmitted periodically (such as each super frame), or transmitted based on the triggering of an event (for example, the time difference information between the carriers changes or the MS accesses the network). This method relatively saves the overhead, but restricts the assignment to some extent, that is, the time difference assigned by the other carrier for different MSs is the same.

Through the above method for obtaining information, the MS obtains, according to the received carrier information and frame number information, the resources assigned to the MS and does not need to receive and buffer the data of each frame of all the carriers that may assign resources to the MS. This greatly reduces the amount of data received and buffered by the MS and improves the power saving performance of the MS.

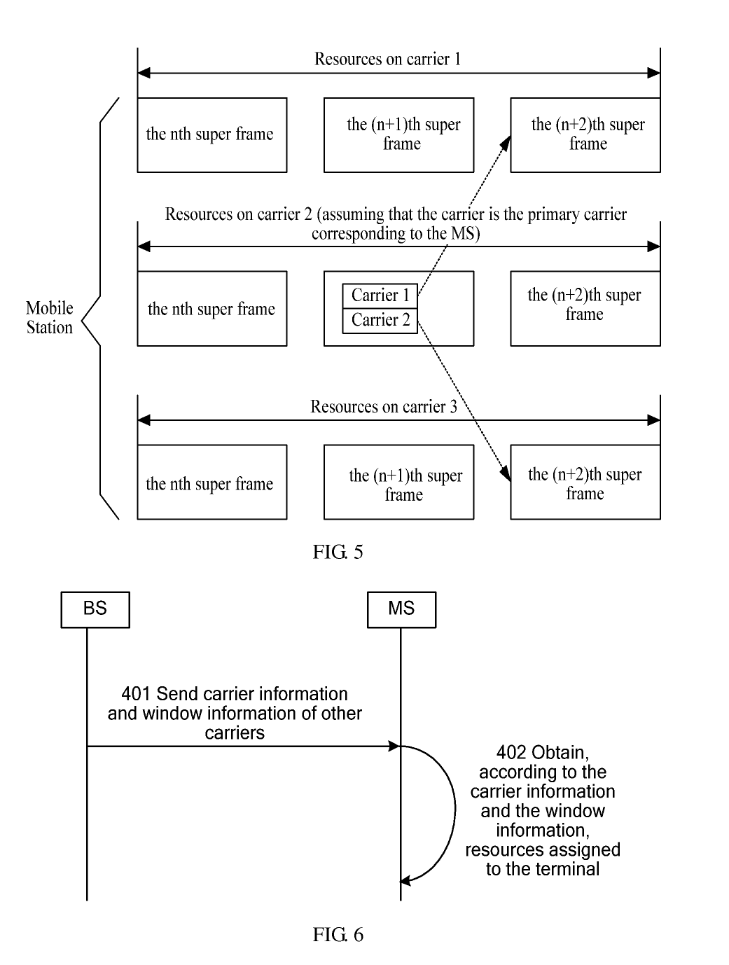

FIG. 6 is a flow chart of signaling of a method for obtaining information according to a third embodiment of the present invention. As shown in FIG. 6, the method includes the following steps.

Step 401: A BS sends carrier information and window information of other carriers to an MS through a primary carrier.

The window information includes active window information or sleep window information, and the BS indicates on the primary carrier corresponding to the MS an active window or a sleep window of the MS on other carriers. Various methods may be used for indicating the window information, for example, indicating a beginning of the active window and a length of the active window, where the beginning includes frame number information or other time indication information, and the unit of the length may be a time unit, such as super frame, frame, sub frame and millisecond; or indicating the beginning and length of the sleep window, the content of which is similar to the method for indicating the active window, so that the details will not be described herein again; or indicating the beginning and end of the active window, where the end includes frame number information or other time indication information, which is similar to the beginning so that the details will not be described herein again, and the beginning and the end of the active window may be indicated in the same frame of the primary carrier, or in separate frames, that is, when the beginning and the end are indicated in the same frame, the size of window is predetermined, while when the beginning and the end are indicated in separate frames, the window is dynamic, and the BS activates or terminates the active window of other carriers through an indication at any time; or indicating the beginning and end of the sleep window, which is similar to the method for indicating the active window, so that the details will not be described herein again.

The carrier information may include information such as a carrier index, a center frequency, or a bandwidth. The frame number information may include a supper frame number, a frame number, or a sub frame number. To optimize and save the number of bits of the frame number, a relative frame number may be adopted to substitute the normal frame number; the relative frame number is the frame number counted from the current frame, and is relative to the sequence of the current frame.

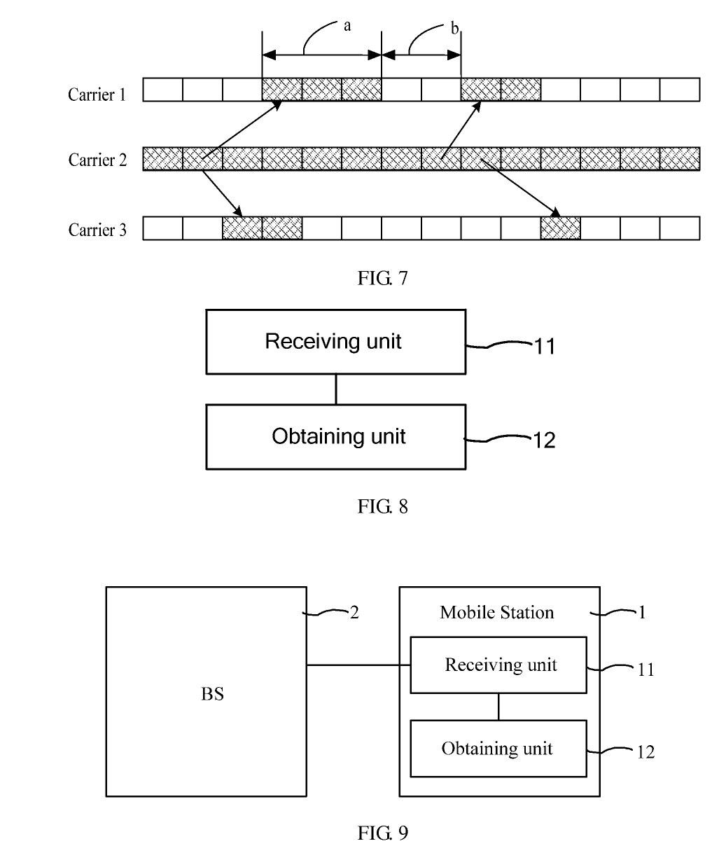

FIG. 7 is a schematic view of a window indication of the method for obtaining information according to the third embodiment of the present invention. As shown in FIG. 7, carrier 2 is the primary carrier corresponding to the MS, carrier 1 and carrier 3 are secondary carriers, and carrier 2 indicates active windows of carrier 1 and carrier 3. In FIG. 7, a represents the active window, and b represents the sleep window.

Step 402: The MS obtains, according to the carrier information and the window information, resources assigned to the MS.

The MS determines, according to the carrier information, the specific one of the other carriers where the resources are assigned, and determines, according to the window information, to obtain the resources on the carrier during time period or starting from which frame. Only in the time period of the active window, the MS will receive and buffer the data frame of the carrier, and reads the corresponding data resources according to the resource assignment information of the primary carrier or the assignment information of the carrier.

Through the above method for obtaining information, the MS receives and buffers the data frame corresponding to the active window of a certain carrier, and does not need to receive and buffer the data of each frame of all the carriers that may assign resources to the MS. This greatly reduces the amount of data received and buffered by the MS, and improves the power saving performance of the MS.

FIG. 8 is a schematic structural view of an MS according to an embodiment of the present invention. As shown in FIG. 8, the MS includes a receiving unit 11, configured to receive carrier information and offset information of other carriers carried on a primary carrier, where the offset information includes frame number information, time difference information or window information, and the other carriers include secondary carriers; and an obtaining unit 12, configured to obtain, according to the carrier information and the offset information, data resources carried on the other carriers.

To enable the MS to better obtain the resources assigned to the MS while ensuring the performance of the system, the receiving unit may include a first receiving module, configured to receive resource assignment information of the other carriers carried on the primary carrier, where the resource assignment information includes the carrier information and the frame number information; correspondingly, the obtaining unit may include a first obtaining module, configured to receive and buffer a data frame indicated by the resource assignment information, and read the data resources in the data frame according to the resource assignment information; or, receive and buffer, according to the resource assignment information, the data resources in a data frame indicated by the resource assignment information, and read the data resources according to a modulation and coding mode indicated in the resource assignment information; or, receive and buffer a data frame indicated by the resource assignment information, read assignment information on the data frame, and read the data resources on the other carriers according to the assignment information.

The receiving unit may further include a second receiving module, configured to receive the time difference information between the primary carrier and the other carriers and resource assignment information of the other carriers carried on the primary carrier, where the resource assignment information includes the carrier information; correspondingly, the obtaining unit may further include a second obtaining module, configured to read, according to the carrier information and the time difference information, the data resources carried on the other carriers; or, receive and buffer a data frame indicated by the resource assignment information, read assignment information on the data frame, and read the data resources on the other carriers according to the assignment information.

In addition, the receiving unit may further include a third receiving module, configured to receive the carrier information of the other carriers carried on the primary carrier and the window information indicating the other carriers on the primary carrier, where the window information includes active window information and sleep window information; correspondingly, the obtaining unit may further include a third obtaining module, configured to read, according to the carrier information and the window information, the data resources carried on the other carriers.

The above MS obtains, through the obtaining unit, the resources assigned to the MS, and does not need to receive and buffer the data of each frame of all the carriers that may assign resources to the MS. This greatly reduces the amount of data received and buffered by the MS, and improves the power saving performance of the MS.

FIG. 9 is a schematic structural view of a system for obtaining information according to an embodiment of the present invention. As shown in FIG. 9, the system includes an MS 1. The MS 1 includes a receiving unit 11, configured to receive carrier information and offset information of other carriers carried on a primary carrier by a BS 2, where the offset information includes frame number information, time difference information or window information, and the other carriers include secondary carriers; and an obtaining unit 12, configured to obtain, according to the carrier information and the offset information, data resources carried on the other carriers.

To enable the MS to better obtain the resources assigned to the MS while ensuring the performance of the system, the receiving unit may include a first receiving module, configured to receive resource assignment information of the other carriers carried on the primary carrier, where the resource assignment information includes the carrier information and the frame number information; correspondingly, the obtaining unit may include a first obtaining module, configured to receive and buffer a data frame indicated by the resource assignment information, and read the data resources in the data frame according to the resource assignment information; or, receive and buffer, according to the resource assignment information, the data resources in a data frame indicated by the resource assignment information, and read the data resources according to a modulation and coding mode indicated in the resource assignment information; or, receive and buffer a data frame indicated by the resource assignment information, read assignment information on the data frame, and read the data resources on the other carriers according to the assignment information.

The receiving unit may further include a second receiving module, configured to receive the time difference information between the primary carrier and the other carriers and resource assignment information of the other carriers carried on the primary carrier, where the resource assignment information includes the carrier information; correspondingly, the obtaining unit may further include a second obtaining module, configured to read, according to the carrier information and the time difference information, the data resources carried on the other carriers; or, receive and buffer a data frame indicated by the resource assignment information, read assignment information on the data frame, and read the data resources on the other carriers according to the assignment information.

In addition, the receiving unit may further include a third receiving module, configured to receive the carrier information of the other carriers carried on the primary carrier and the window information indicating the other carriers on the primary carrier, where the window information includes active window information and sleep window information; correspondingly, the obtaining unit may further include a third obtaining module, configured to read, according to the carrier information and the window information, the data resources carried on the other carriers.

Through the above system, the MS obtains, through the obtaining unit, the resources assigned to the MS, and does not need to receive and buffer the data of each frame of all the carriers that may assign resources to the MS. This greatly reduces the amount of data received and buffered by the MS, and improves the power saving performance of the MS.

Finally, it should be noted that the above embodiments are merely provided for describing the technical solutions of the present invention, but not intended to limit the present invention. It should be understood by persons of ordinary skill in the art that although the present invention has been described in detail with reference to the embodiments, modifications can be made to the technical solutions described in the embodiments, or equivalent replacements can be made to some technical features in the technical solutions, as long as such modifications or replacements do not depart from the spirit and scope of the present invention.

What is claimed is:

1. A method for obtaining information, the method comprising:
receiving carrier information and offset information of other carriers carried on a primary carrier, wherein the offset information comprises frame number information, time difference information or window information and wherein the other carriers comprise secondary carriers; and
obtaining data resources carried on the other carriers according to the carrier information and the offset information.

2. The method for obtaining information according to claim 1,
wherein receiving the carrier information and the offset information comprises receiving resource assignment information of the other carriers carried on the primary carrier, wherein the resource assignment information comprises the carrier information and the frame number information; and
wherein obtaining the data resources comprises:
receiving and buffering a data frame indicated by the resource assignment information and reading the data resources in the data frame according to the resource assignment information; or
receiving and buffering, according to the resource assignment information, the data resources in a data frame indicated by the resource assignment information and reading the data resources according to a modulation and coding mode indicated in the resource assignment information; or
receiving and buffering a data frame indicated by the resource assignment information, reading assignment information on the data frame, and reading the data resources on the other carriers according to the assignment information.

3. The method for obtaining information according to claim 2, wherein before reading the data resources according to the modulation and coding mode indicated in the resource assignment information, the method further comprises obtaining the modulation and coding mode delivered through broadcast, unicast or a preset manner.

4. The method for obtaining information according to claim 1,
wherein receiving the carrier information and the offset information comprises:
receiving the time difference information between the primary carrier and the other carriers; and
receiving resource assignment information of the other carriers carried on the primary carrier, wherein the resource assignment information comprises the carrier information; and
wherein obtaining the data resources comprises:
receiving and buffering a data frame indicated by the carrier information and the time difference information, and reading the data resources in the data frame according to the resource assignment information; or
receiving and buffering the data resources in a data frame indicated by the carrier information and the time difference information, and reading the data resources according to a modulation and coding mode indicated in the resource assignment information; or
receiving and buffering a data frame indicated by the carrier information and the time difference information, reading assignment information on the data frame, and reading the data resources on the other carriers according to the assignment information.

5. The method for obtaining information according to claim 4, wherein the receiving the time difference information between the primary carrier and the other carriers comprises:
receiving the time difference information between the primary carrier and the other carriers transmitted by a Base Station (BS) through broadcast or unicast; or
receiving preset time difference information between the primary carrier and the other carriers.

6. The method for obtaining information according to claim 1,
wherein receiving the carrier information and the offset information comprises:
receiving the carrier information of the other carriers carried on the primary carrier; and
receiving the window information indicating the other carriers on the primary carrier, wherein the window information comprises active window information or sleep window information; and
wherein obtaining the data resources comprises:
receiving and buffering a data frame of the carrier according to the carrier information and the window information, and reading the corresponding data resources.

7. The method for obtaining information according to claim 6, wherein the active window information comprises an active window beginning, the active window beginning comprising the frame number information or time indication information; and the receiving and buffering the data frame of the carrier according to the carrier information and the window information, and reading the corresponding data resources comprises:
receiving and buffering the data frame indicated by the carrier information and the window information, and reading the data resources in the data frame according to resource assignment information; or
receiving and buffering, according to resource assignment information, the data resources in the data frame indicated by the carrier information and the window information, and reading the data resources according to a modulation and coding mode indicated in resource assignment information; or
receiving and buffering the data frame indicated by the carrier information and the window information, reading assignment information on the data frame, and reading the data resources on the other carriers according to the assignment information.

8. The method for obtaining information according to claim 7, wherein the active window information further comprises an active window length.

9. The method for obtaining information according to claim 7, wherein the active window information further comprises an active window end.

10. The method for obtaining information according to claim 9, wherein the active window beginning and the active window end are indicated through the same frame.

11. The method for obtaining information according to claim 9, wherein the active window beginning and the active window end are indicated through different frames.

12. The method for obtaining information according to claim 2, wherein the resource assignment information or the assignment information comprises physical layer encoding and decoding information and/or time-frequency resource block information.

13. A mobile station, comprising:
a receiving unit, configured to receive carrier information and offset information of other carriers carried on a primary carrier, wherein the offset information comprises frame number information, time difference information or window information, and wherein the other carriers comprise secondary carriers; and
an obtaining unit, configured to obtain data resources carried on the other carriers according to the carrier information and the offset information.

14. The mobile station according to claim 13,
wherein the receiving unit comprises a first receiving module, configured to receive resource assignment information of the other carriers carried on the primary carrier, wherein the resource assignment information comprises the carrier information and the frame number information; and
wherein the obtaining unit comprises:
a first obtaining module, configured to receive and buffer a data frame indicated by the resource assignment information, and read the data resources in the data frame according to the resource assignment information; or
a first obtaining module, configured to receive and buffer, according to the resource assignment information, the data resources in a data frame indicated by the resource assignment information, and read the data resources according to a modulation and coding mode indicated in the resource assignment information; or
a first obtaining module, configured to receive and buffer a data frame indicated by the resource assignment information, read assignment information on the data frame, and read the data resources on the other carriers according to the assignment information.

15. The mobile station according to claim 13,
wherein the receiving unit comprises a second receiving module, configured to receive the time difference information between the primary carrier and the other carriers and resource assignment information of the other carriers carried on the primary carrier, wherein the resource assignment information comprises the carrier information; and
wherein the obtaining unit comprises:
a second obtaining module, configured to receive and buffer a data frame indicated by the carrier information and the time difference information, and read the data resources in the data frame according to the resource assignment information; or
a second obtaining module, configured to receive and buffer, according to the resource assignment information, the data resources in a data frame indicated by the carrier information and the time difference information, and read the data resources according to a modulation and coding mode indicated in the resource assignment information; or
a second obtaining module, configured to receive and buffer a data frame indicated by the carrier information and the time difference information, read assignment information on the data frame, and read the data resources on the other carriers according to the assignment information.

16. The mobile station according to claim 13,
wherein the receiving unit comprises a third receiving module, configured to receive the carrier information of the other carriers carried on the primary carrier and the window information indicating the other carriers on the primary carrier, wherein the window information comprises active window information and sleep window information; and
wherein the obtaining unit comprises a third obtaining module, configured to receive and buffer a data frame of the carrier according to the carrier information and the window information, and read the corresponding data resources.

17. A system for obtaining information, comprising a mobile station, wherein the mobile comprises:
a receiving unit, configured to receive carrier information and offset information of other carriers carried on a primary carrier by a base station, wherein the offset information comprises frame number information, time difference information or window information, and the other carriers comprise secondary carriers; and
an obtaining unit, configured to obtain data resources carried on the other carriers according to the carrier information and the offset information.
